(19) United States
(12) Patent Application Publication
(10) Pub. No.: US 2017/0150385 A1
(43) Pub. Date: May 25, 2017

(54) REPORTING CSI-RS BASED RADIO RESOURCE MANAGEMENT MEASUREMENTS CONDITIONALLY TO CRS-BASED MEASUREMENTS

(71) Applicant: Nokia Solutions and Networks Oy, Espoo (FI)

(72) Inventors: Tero Henttonen, Espoo (FI); Timo Erkki Lunttila, Espoo (FI)

(21) Appl. No.: 15/309,889

(22) PCT Filed: May 9, 2014
(86) PCT No.: PCT/EP2014/059553

§ 371 Date: Nov. 9, 2016

(51) Int. Cl. H04W 24/10; H04L 5/00; H04W 24/02

(52) U.S. Cl. CPC H04W 24/10; H04W 24/02; H04L 5/0048; H04L 5/0091

(57) ABSTRACT

A method for enhancing discovery procedures in a dense ON/OFF switchable small-cells scenario, and comprising: a user device, UE, receiving a radio-resource-management-measurement-reporting configuration including a first and a second condition defined by a network node, such as an eNodeB; The first condition including a condition based on a channel-state-information-reference-signal, CSI-RS, measurement; The second condition comprising a condition based on a cell-specific-reference signal, CRS, measurement; The UE reporting, according to the radio-resource-management-measurement-reporting configuration, at least one radio-resource-management, RRM, measurement based on a channel-state-information reference signal, CSI-RS, only if both the first condition and the second condition are fulfilled.

### BACKGROUND

### Field

Embodiments of the invention relate to reporting radio resource management related information.

### Description of the Related Art

Long-Term Evolution (LTE) or Long-Term Evolution Advanced is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE or LTE-Advanced has seen extensive deployment in a wide variety of contexts involving the communication of data.

### SUMMARY:

According to a first embodiment, a method may include receiving or defining, by a user device, a radio-resource-management-measurement-reporting configuration comprising a first and a second condition. The method may also include determining, by the user device, if the first condition has been fulfilled, wherein the first condition comprises a condition based on a channel-state-information-reference-signal measurement. The method may also include determining if the second condition has been fulfilled. The second condition comprises a condition based on a cell-specific-reference signal measurement. The method may also include reporting, according to the radio-resource-management-measurement-reporting configuration, at least one radio-resource-management measurement based on a channel-state-information reference signal, if both the first condition and the second condition are fulfilled.

In the method of the first embodiment, the radio-resource-management-measurement reporting configuration comprises a channel-state-information-reference-signal resource configuration.

In the method of the first embodiment, the radio-resource-management-measurement-reporting configuration comprises an indication of an association between the channel-state-information-reference-signal resource configuration and a cell identity.

In the method of the first embodiment, the association is determined based on a scrambling identity of the channel-state-information-reference signal.

In the method of the first embodiment, the first condition and/or the second condition comprises at least one received signal power or received signal quality measurement.

In the method of the first embodiment, a first offset is added to the first condition and/or a second offset is added to the second condition.

In the method of the first embodiment, the radio-resource-management-measurement-reporting configuration comprises combining the configuration of the first condition and the configuration of the second condition to a third configuration identified by a third identity.

In the method of the first embodiment, the radio-resource-management-measurement-reporting configuration comprises adding the first condition to the configuration of the second condition.

In the method of the first embodiment, the radio-resource-management-measurement-reporting configuration comprises adding the first condition inside the second condition in the second configuration.

In the method of the first embodiment, the second condition comprises measurements based on a serving cell.

In the method of the first embodiment, the second condition comprises measurements based on a neighboring cell.

According to a second embodiment, an apparatus may include_receiving/defining means for receiving or defining a radio-resource-management-measurement-reporting configuration comprising a first and a second condition. The apparatus may also include first determining means for determining if the first condition has been fulfilled. The first condition comprises a condition based on a channel-state-information-reference-signal measurement. The apparatus may also include second determining means for determining if the second condition has been fulfilled. The second condition comprises a condition based on a cell-specific-reference signal measurement. The apparatus may also include reporting means for reporting, according to the radio-resource-management-measurement-reporting configuration, at least one radio-resource-management measurement based on a channel-state-information reference signal, if both the first condition and the second condition are fulfilled.

In the apparatus of the second embodiment, the radio-resource-management-measurement-reporting configuration comprises a channel-state-information-reference-signal resource configuration.

In the apparatus of the second embodiment, the radio-resource-management-measurement-reporting configuration comprises an indication of an association between the channel-state-information-reference-signal resource configuration and a cell identity.

In the apparatus of the second embodiment, the association is determined based on a scrambling identity of the channel-state-information-reference signal.

In the apparatus of the second embodiment, the first condition and/or the second condition comprises at least one received signal power or received signal quality measurement.

In the apparatus of the second embodiment, a first offset is added to the first condition and/or a second offset is added to the second condition.

In the apparatus of the second embodiment, the radio-resource-management-measurement-reporting configuration comprises combining the configuration of the first condition and the configuration of the second condition to a third configuration identified by a third identity.

In the apparatus of the second embodiment, the radio-resource-management-measurement-reporting configuration comprises adding the first condition to the configuration of the second condition.

In the apparatus of the second embodiment, the radio-resource-management-measurement-reporting configuration comprises adding the first condition inside the second condition in the second configuration.

In the apparatus of the second embodiment, the second condition comprises measurements based on a serving cell.

In the apparatus of the second embodiment, the second condition comprises measurements based on a neighboring cell.

According to a third embodiment, an apparatus can include at least one processor. The apparatus can include at least one memory including computer program code. The at least one memory and the computer program code can be configured, with the at least one processor, to cause the apparatus at least to receive or define a radio-resource-management-measurement-reporting configuration comprising a first and a second condition. The apparatus can also be caused to determine if the first condition has been fulfilled. The first condition comprises a condition based on a channel-state-information-reference-signal measurement. The apparatus can also be caused to determine if the second condition has been fulfilled.

The second condition comprises a condition based on a cell-specific-reference signal measurement. The apparatus can also be caused to report, according to the radio-resource-management measurement reporting configuration, at least one radio-resource-management measurement based on a channel-state-information reference signal, if both the first condition and the second condition are fulfilled.

According to a fourth embodiment, a computer program product may include software code portions for performing the steps of the method of the first embodiment, when said product is run on the computer.

According to a fifth embodiment, a method may include defining, by a node, a radio-resource-management-measurement reporting configuration comprising a first and a second condition. The method may also include indicating the radio-resource-management-measurement-reporting configuration comprising the first and the second condition to a user device for radio-resource-management-measurement reporting, and/or indicating an association between a channel-state-information-reference-signal resource configuration and a cell identity to the user device for radio-resource-management-measurement reporting.

In the method of the fifth embodiment, the radio-resource-management-measurement-reporting configuration comprises a channel-state-information-reference-signal resource configuration.

In the method of the fifth embodiment, the association between the channel-state-information-reference-signal resource configuration and the cell identity is comprised in the radio-resource-management-measurement-reporting configuration.

In the method of the fifth embodiment, the association is a scrambling identity of the channel-state-information-reference signal.

In the method of the fifth embodiment, the first condition and/or the second condition comprises at least one received signal power or received signal quality measurement.

In the method of the fifth embodiment, a first offset is added to the first condition and/or a second offset is added to the second condition.

In the method of the fifth embodiment, the radio-resource-management-measurement-reporting configuration comprises combining the configuration of the first condition and the configuration of the second condition to a third configuration identified by a third identity.

In the method of the fifth embodiment, the radio-resource-management-measurement-reporting configuration comprises adding the first condition to the configuration of the second condition.

In the method of the fifth embodiment, the radio-resource-management-measurement-reporting configuration comprises adding the first condition inside the second condition in the second configuration.

In the method of the fifth embodiment, the second condition comprises measurements based on a serving cell.

In the method of the fifth embodiment, the second condition comprises measurements based on a neighboring cell.

According to a sixth embodiment, an apparatus may include defining means for defining a radio-resource-management-measurement-reporting configuration comprising a first and a second condition. The apparatus may also include indicating means for indicating the radio-resource-management-measurement-reporting configuration comprising the first and the second condition to a user device for radio-resource-management-measurement reporting, and/or indicating an association between a channel-state-information-reference-signal resource configuration and a cell identity to a user device for radio-resource-management-measurement reporting.

In the apparatus of the sixth embodiment, the radio-resource-management-measurement-reporting configuration comprises a channel-state-information-reference-signal resource configuration.

In the apparatus of the sixth embodiment, the association between the channel-state-information-reference signal resource configuration and the cell identity is comprised in the radio-resource-management-measurement-reporting configuration.

In the apparatus of the sixth embodiment, the association is a scrambling identity of the channel-state-information-reference-signal.

In the apparatus of the sixth embodiment, the first condition and/or the second condition comprises at least one received signal power or received signal quality measurement.

In the apparatus of the sixth embodiment, a first offset is added to the first condition and/or a second offset is added to the second condition.

In the apparatus of the sixth embodiment, the radio-resource-management-measurement-reporting configuration comprises combining the configuration of the first condition and the configuration of the second condition to a third configuration identified by a third identity.

In the apparatus of the sixth embodiment, the radio-resource-management-measurement-reporting configuration comprises adding the first condition to the configuration of the second condition.

In the apparatus of the sixth embodiment, the radio-resource-management-measurement-reporting configuration comprises adding the first condition inside the second condition in the second configuration.

In the apparatus of the sixth embodiment, the second condition comprises measurements based on a serving cell.

In the apparatus of the sixth embodiment, the second condition comprises measurements based on a neighboring cell.

According to a seventh embodiment, an apparatus includes at least one processor. The apparatus may also include at least one memory including computer program code. The at least one memory and the computer program code may be configured, with the at least one processor, to cause the apparatus at least to define a radio-resource-management-measurement-reporting configuration comprising a first and a second condition. The apparatus may also be caused to indicate the radio-resource-management-measurement-reporting configuration comprising the first and the second condition to a user device for radio-resource-management-measurement reporting, and/or indicating an association between a channel-state-information-reference-signal resource configuration and a cell identity to a user device for radio-resource-management-measurement reporting.

According to an eighth embodiment, a computer program product for a computer may include software code portions for performing the steps of the fifth embodiment, when said product is run on the computer.

### BRIEF DESCRIPTION OF THE DRAWINGS

For proper understanding of the invention, reference should be made to the accompanying exemplifying drawings, wherein:

FIG. 1 illustrates an example of reporting configurations and measurement-objects.

FIG. 2 illustrates linking measurement identification together in accordance with one embodiment.

FIG. 3 illustrates linking two reporting configurations in accordance with one embodiment.

FIG. 4 illustrates linking separate reference configurations in accordance with one embodiment.

FIG. 5 illustrates a flow diagram of a method according to one embodiment.

FIG. 6 illustrates a flow diagram of another method according to one embodiment.

FIG. 7 illustrates an apparatus in accordance with one embodiment.

FIG. 8 illustrates an apparatus in accordance with another embodiment.

FIG. 9 illustrates an apparatus in accordance with another embodiment.

FIG. 10 illustrates an apparatus in accordance with another embodiment.

FIG. 11 illustrates an apparatus in accordance with another embodiment.

### DETAILED DESCRIPTION:

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

Embodiments of the invention relate to reporting radio resource management measurements measured based on channel-state-information-reference signals. Some embodiments of the present invention may be applicable to a Long-Term-Evolution-Advanced (LTE-Advanced) system, which is described by 3GPP LTE Release 12. Additionally, embodiments of the present invention may be directed to enhancing small-cell ON/OFF switching and to enhancing related discovery procedures.

In the LTE or LTE-Advanced, UE (or user device) measurement configuration consists of three separate configuration objects: measurement objects, reporting configurations and measurement identities. A measurement object represents a measured carrier frequency. A reporting configuration represents a measurement event, its configuration and the parameters associated with the measurement event. A measurement identity links exactly one measurement object and exactly one reporting configuration together. However, the one-to-one mapping of the measurement identity is not exclusive, i.e. a measurement object or a reporting configuration may be associated to multiple measurement identities.

An ongoing work item, entitled “Small Cell Enhancements—Physical-Layer Aspects,” describes on/off operation of small cells. The work item is currently ongoing in 3GPP, and the work item is lead by RAN WG1 (Work Item Description (WID)). When performing the on/off operation of small cells, the on/off switching of small cells is performed in accordance with facilitating, for example, a reduction of network energy consumption and/or a reduction of interference during the times when a network load is low.

Cells that perform on/off switching may transmit discovery signals supporting at least cell identification, coarse time/frequency synchronization, intra-frequency/inter-frequency Radio-Resource-Management (RRM) measurement of cells, and/or Quasi-CoLocation (QCL). QCL may not be necessary or possible, depending on the specific procedure. Using discovery procedure/signals includes the supporting of discovery and measurement enhancements in downlink (DL) and in related procedures.

The use of discovery procedures/signals was further discussed in the 3GPP RAN1 meeting #76 with the following main agreements. Discovery signals may be used for measurements like Reference-Signal-Received-Power (RSRP) and Reference-Signal-Received-Quality (RSRQ). Discovery signals may include Primary-Synchronization-Signals (PSS), Secondary-Synchronization-Signals (SSS), and one or more Cell-specific Reference Signals (CRS), Channel-State-Information-Reference-Signals (CSI-RS), and/or Positioning-Reference-Signals (PRS).

The current use of Radio-Resource-Management (RRM) measurements is based on the use of measurement events. Each event defines triggering conditions and network-configured parameters associated with the event. The parameters define in which conditions the event shall trigger and what the UE shall report when the event is triggered. Additionally, each event has an entering and leaving condition, which determines when the event is considered to be valid and when it is no longer valid after the entering conditions has first been triggered. Further, a time-to-trigger (TTT) may be defined for each event so that the event only triggers if the event is valid for a period of time equal to the value of TTT.

Embodiments of the present invention relate to a method of performing discovery procedures and of performing related Radio-Resource-Management (RRM) measurements. Embodiments of the present invention also relate to reporting mechanisms that are based on discovery signals (DS) to support transmission-point identification, and reporting mechanisms based on Channel-State-Information-Reference-Signals (CSI-RS).

Embodiments of the present invention may be directed to “single-cell ID” operation with multiple transmission points. A similar setting to the “single-cell ID” is the “Coordinated-Multipoint (CoMP) Scenario 4” setting. These settings/scenarios may be characterized as having multiple transmission points (TP), corresponding to different physical locations, that share a same Physical Cell ID (PCI). The TPs appear as Channel-State-Information-Reference-Signal (CSI-RS) resources to the user equipment (UEs) in the cell. In addition to performing the conventional Cell-specific-Reference-Signal-based (CRS-based) RRM measurements (namely RSRP and RSRQ), the UE may also be configured to perform Radio-Resource-Management (RRM) measurements based on CSI-RS to assist the network in selecting the preferred transmission point within the cell.

Coordinated-Multipoint (CoMP) in Release 11 has generally been directed to measurements based on Intra-frequency CSI-RS. By focusing on measurements based on Intra-frequency CSI-RS, a network may be assisted in choosing the best transmission points to be included into a CoMP CSI reporting set, with the TPs being located either in the same cell as each other (corresponding to a CoMP scenario 4) or located within different cells (corresponding to a CoMP Scenario 3).

However, CSI-RS is not anticipated to be used for actual cell selection (which is assumed to be based on CRS). The measurement events discussed in Release 11 are listed in 3GPP contribution R2-123951 Email discussion report on [78#52b] LTE/COMP: CSI-RS Measurement Framework, Samsung.

In Release 12, the applicable scenario may be slightly different. In the context of small-cell ON/OFF operation and discovery, one goal is to find the best cell and, potentially, the best TP, regardless of whether the cell is “on” or “off”, or which carrier the cell is on. Also, inter-frequency measurements are to be considered. Special interest has been devoted to super-dense scenarios, where a plurality of small cells (or transmission points) may be deployed reasonably close to each other.

Difficulties in identifying the desired TP may occur when the UE finds a large number of transmission points, belonging to various cells. Performing the existing RRM measurement reporting events may easily trigger a vast amount of reports that may cause significant overhead, especially in the uplink (UL). Additionally, it is generally not sufficient for the UE to only know the Channel-State-Information-Reference-Signal-Received-Power/Channel-State-Information-Reference-Signal-Received-Quality (CSI-RSRP/CSI-RSRQ) for a TP. Only knowing the CSI-RSRP/CSI-RSRQ by the UE is generally insufficient because a large part of the operation in LTE (such as, for example, performing control channel reception, data demodulation with many of the transmission modes, fine time/frequency synchronization, cell selection, and handover, etc.) is fundamentally based on receiving a Cell-specific Reference Signal (CRS) and knowing a physical Cell ID which is associated with CRS.

Therefore, even if a UE observes and reports a high CSI-RSRP or CSI-RSRQ for a TP, if the (CRS-based) RSRP/RSRQ of the associated physical cell is low, it would not be desirable for the network to handover the UE to that physical cell. Therefore, CSI-RSRP/RSRQ reports for TPs that are associated with cells that have low (CRS-based) RSRP/RSRQ are typically obsolete reports. Embodiments of the present invention address this issue and provide optimized solutions for RRM measurements and reporting.

Embodiments of the present invention allow a network to improve coordination with transmission points (for which the CSI-RSRP/CSI-RSRQ is reported for). In embodiments of the present invention, the network may indicate to a UE that CSI-RS-based RRM measurements are conditional to CRS-based measurements.

In one embodiment, user device receives or defines a radio-resource-management-measurement-reporting configuration comprising a first and a second condition, determines, if the first condition has been fulfilled, wherein the first condition comprises a condition based on a channel-state-information-reference-signal measurement and determines if the second condition has been fulfilled, wherein the second condition comprises a condition based on a cell-specific-reference signal measurement and reports, according to the radio-resource-management-measurement-reporting configuration, at least one radio-resource-management measurement based on a channel-state-information reference signal, if both the first condition and the second condition are fulfilled. Correspondingly, in one embodiment a node defines a radio-resource-management-measurement-reporting configuration comprising a first and a second condition and indicates the radio-resource-management-measurement-reporting configuration comprising the first and the second condition to a user device for radio-resource-management-measurement reporting, and/or indicates an association between a channel-state-information-reference-signal resource configuration and a cell identity to the user device for radio-resource-management-measurement reporting.

In one embodiment, the radio-resource-management-measurement-reporting configuration comprising the first and second condition, further comprises a first configuration for the first condition and a second configuration for the second condition, wherein the first configuration and/or the second configuration comprises indication of at least one of the following: of measurement gaps, measurement bandwidth, carrier frequency, physical cell identity (ID), discontinuous reception (DRX) configuration, time-to-trigger, s-Measure, public land mobile network (PLMN) identity, configuration on restrictions on measurement occasion times, type of measured reference symbols, measurement interval and filtering parameters.

Conditional triggering of CSI-RS-based measurement events may be realized, for example, in the following ways. The transmission of CSI-RSRP/CSI-RSRQ reports may be triggered if both a predefined first condition depending on a CSI-RS-based measurement is fulfilled, and if the CRS-based RSRP/RSRQ measurement for the associated cell fulfils a specific second condition. The first and second conditions may be different and they may be checked in a different order.

The conditions for CSI-RS/CRS based measurements may be based on a measured signal power (such as RSRP, for example) or measured signal quality (such as RSRQ or RSSI, for example) relative to the serving cell and an offset value.

In one embodiment, the cell associated with a given CSI-RS resource (such as a transmission point) is indicated to the UE. In one embodiment, the CSI-RS resource may be included in the RRM measurement reporting configuration or in the measurement identity linked to the reporting configuration.

The UE may determine the cell based on a CSI-RS scrambling identity of a TP. A CSI-RS scrambling identity may be used for initializing a pseudo-random sequence generator to generate a CSI-RS sequence and is the same as the physical cell identity unless configured otherwise via RRC signaling. There may be a one-to-one mapping between the TP's CSI-RS scrambling identity and the PCI of the cell that is assumed to be associated with the given TP. This one-to-one mapping may be accomplished via implicit mapping (such as scrambling id=PCI, or scrambling id=503-PCI, for example) or explicit mapping (mapping indicated to the UE via RRC configuration).

In embodiments of the present invention, an event condition (which may be a CSI-RS-based event) may be implemented in several ways. Multiple reporting configurations and measurement objects may be defined for the UE, but not all configurations/objects may be in use at a given point of time. The multiple reporting configurations and measurement objects are not necessarily restricted to CSI-RS. The multiple reporting configurations and measurement objects may also pertain to CRS measurements.

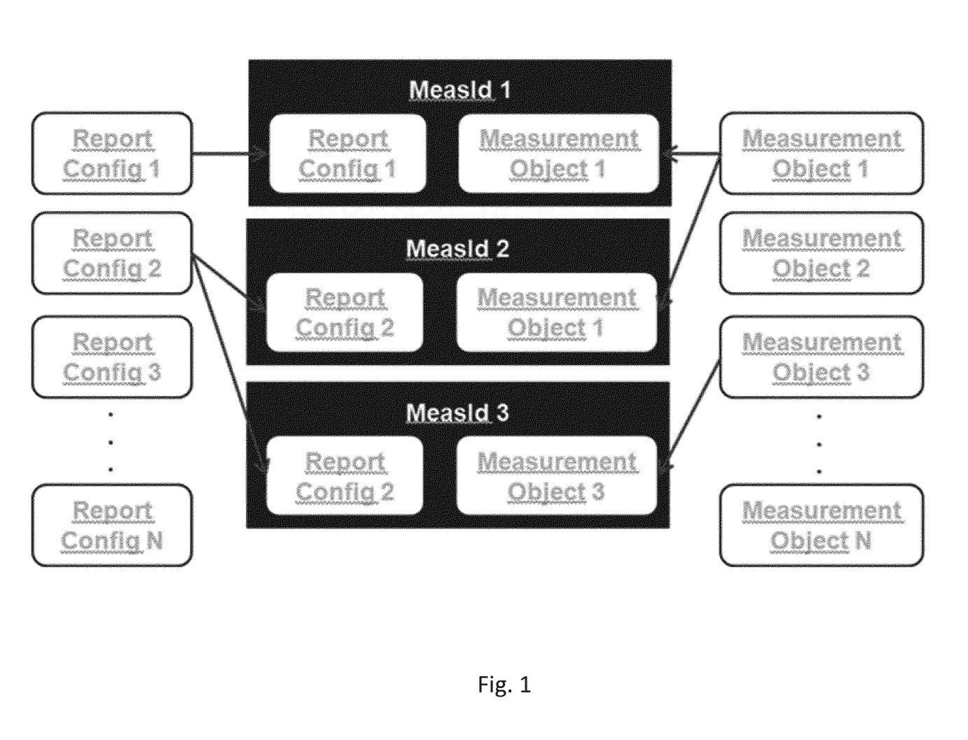

FIG. 1 illustrates reporting configurations and measurement-objects in accordance with one embodiment. In general, the active events (such as measurements identities in 36.331) have the structure of linking a single measurement object with a single reporting configuration, as illustrated in FIG. 1. A reporting configuration may also be linked with multiple measurement objects, and a measurement object may be linked to multiple reporting configurations, but each configured measurement identity consists of linking one reporting configuration with one measurement object.

The configuration of linking a CSI-RS and CRS reporting configurations together may be carried out in various ways. In one embodiment, two measurement identities, one for CSI-RS and one for CRS measurements, are linked together by a new identity which may for example be called a “linking identity”. In another embodiment, the CSI-RS reporting configuration is added to the measurement identity as an additional (optional) reporting configuration, i.e. making the measurement identity mapping of two reporting configurations to one measurement object. In yet another embodiment, the measurement identity configuration is retained but CSI-RS reporting configuration is added to the CRS reporting configuration, so that the CRS reporting configuration is the one referred to in the measurement identity. In yet another embodiment, the measurement identity configuration is retained but CRS reporting configuration is added to the CSI-RS reporting configuration, so that the CSI-RS reporting configuration is the one referred to in the measurement identity.

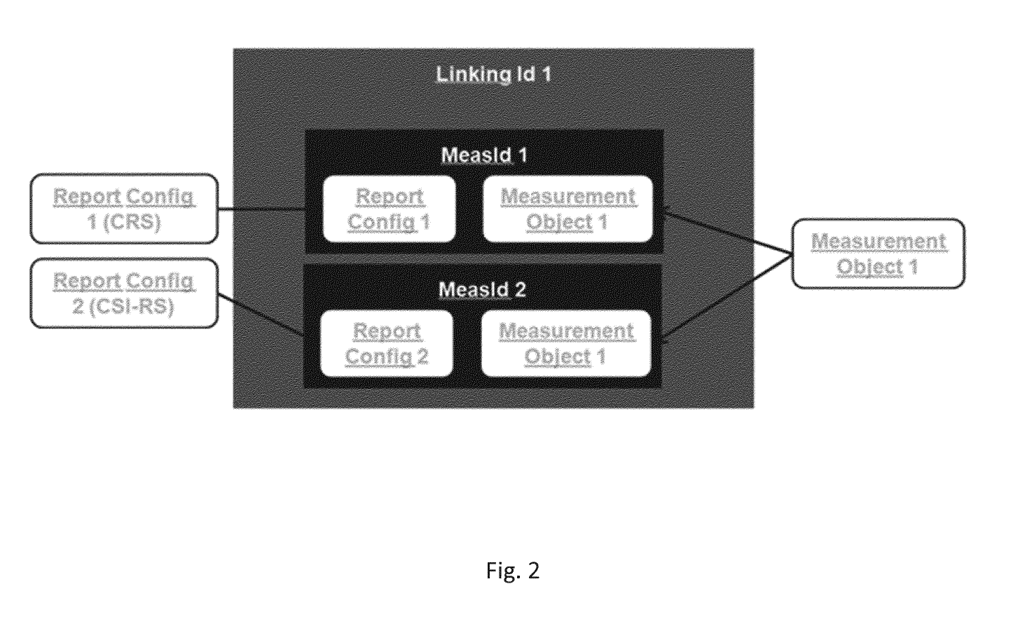

Embodiments of the present invention may adopt a similar structure, with additional modifications, for the CSI-RS based measurements as well. In one way, two measurement identities (IDs) may be linked together via a new top-level entity (referred to as a “linking ID,” for example). FIG. 2 illustrates linking two measurement identities in accordance with one embodiment.

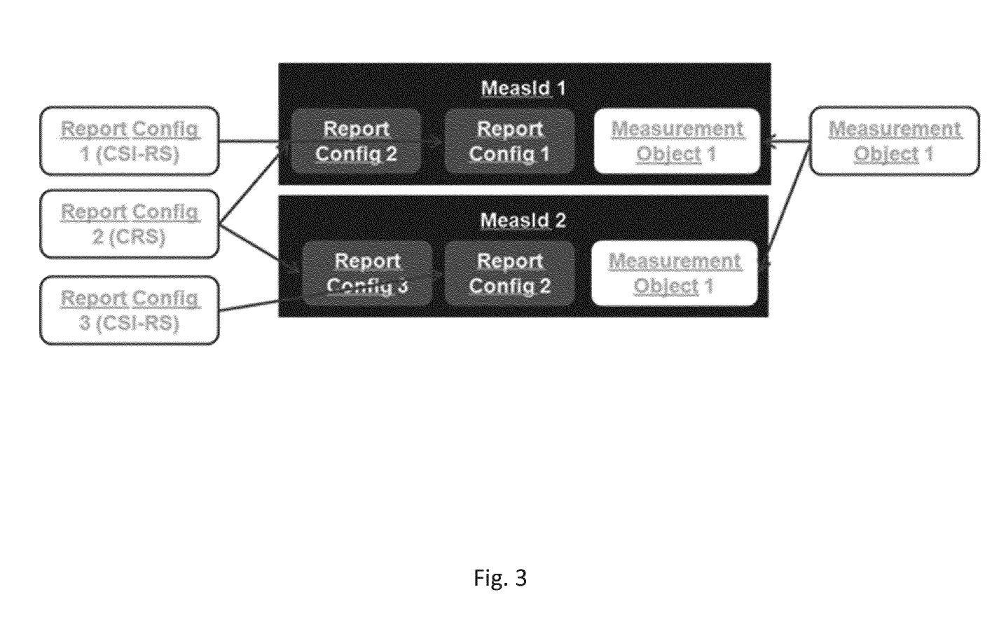

Further, two reporting configurations may be linked to a single measurement identity, indicating that the conditions of both reporting configurations are to be triggered in order for an event to trigger. FIG. 3 illustrates linking two reporting configurations in accordance with one embodiment.

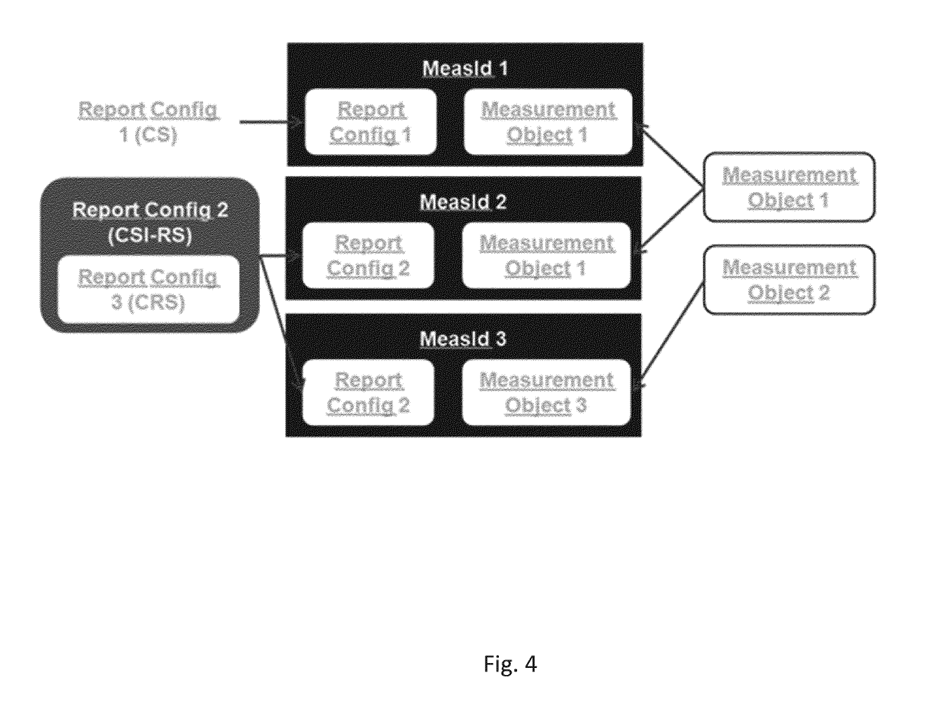

A separate Cell-specific Reference Signal (CRS) based reporting configuration and a CSI-RS based reporting configuration may be linked, so that the CSI-RS based report may only be triggered if the configured CRS based reporting condition is also fulfilled and reporting has been triggered. FIG. 4 illustrates linking a CRS based reporting configuration with a CSI-RS based reporting configuration in accordance with one embodiment.

Additionally, mapping the scrambling ID of the CSI-RS to a reported PCI of a CRS based report may be realized in multiple ways. CRS-based reports have a fixed one-to-one mapping to a PCI (the UE reports to the evolved Node B a PCI of the cell that the UE has found). CSI-RS based measurements may need to be mapped to a CRS based report, or, in other words, to a PCI. Examples of mapping the scrambling ID to a reported PCI are shown below:
Scrambling id=PCI (direct implicit mapping)
Scrambling id=503-PCI (implicit mapping with scrambling ID+PCI=max PCI value)
Scrambling id modulo X=PCI, where X<504 (implicit mapping with reduction of PCI space to fewer values)
Signalling a mapping table that indicates how a scrambling ID generates PCI. Such a mapping may be, for example, one-to-one (i.e., one scrambling id maps to one PCI) or many-to-one (i.e., several scrambling ids map to one PCI). For example, such explicit mapping could be according to either option:1) scrambling id 1→PCI5, scrambling id 3→PCI 56, other scrambling ids→PCI 503; 2) scrambling id 0-20=PCI 1, scrambling id 21-100=PCI 2, other scrambling ids=PCI 0, etc.)

According to embodiments of the present invention, with the measurement event A3, for example, the entering condition for the event may be described as follows: Mn+Ofn+Ocn−Hys>Mp+Ofp+Ocp+Off, where Mn is the measurement result of the neighbour cell (in this case, a cell in the OFF-state), Mp is the measurement result of the serving PCell (in this case, a cell in the ON-state), Hys is the hysteresis parameter of the event, Ofn and Ofp and the frequency-specific offsets for the neighbour cell and serving cell frequencies (respectively), Ocn and Ocp are the CIOs for the neighboring and serving cells (respectively), and Off is the network-configured handover offset for the event.

An operating assumption may be as follows: Ofn=Ocn=Hys=Ofp=Ocp=0. With this operating assumption, the earlier equation may be more simply expressed as: Mn>Mp+Off.

As discussed above, CRS-based RRM measurements are supported. The same basic principles may be applicable to the CSI-RS-based RRM measurement reporting as well. For embodiments of the present invention, the above-described entering condition may now be further modified to be expressed as: Mn_{CRS}>Mp_{CRS}+Off_{CRS} AND Mn_{CSI-RS}>Mp_{CSI-RS}+Off_{CSI-RS}, where the subscripts “CRS” and “CSI-RS” refer to CRS and CSI-RS-based measurement results, respectively, where the “AND” expressed above refers to the logical AND operation, i.e., logical conjunction. In other words, the above equation captures the event entering condition, for example, both CRS-based and CSI-RS-based measurement results must be triggered for the event entering condition to be fulfilled.

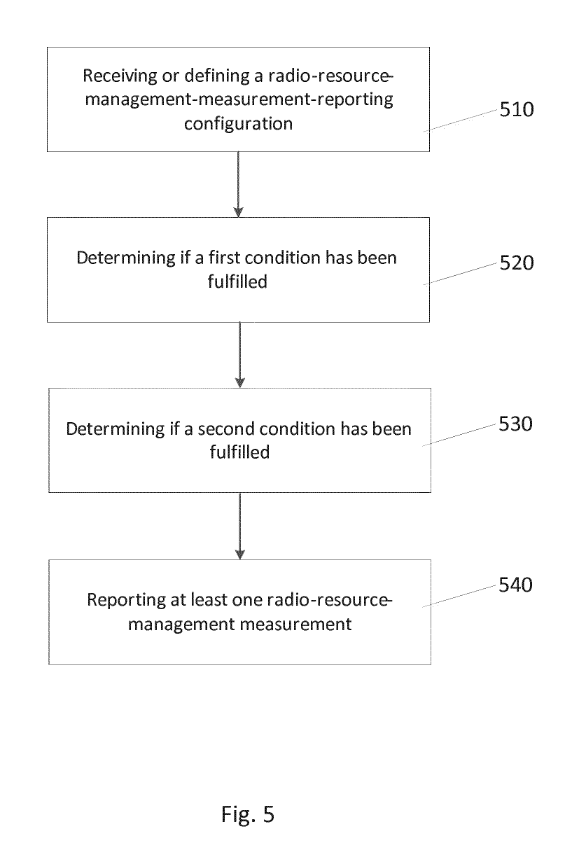

FIG. 5 illustrates a logic flow diagram of a method according to an embodiment of the invention. More detailed examples and further embodiments are described above. The embodiment of the method may be carried out by a user device, user equipment or user terminal. The method illustrated in FIG. 5 includes, at 510, receiving or defining a radio-resource-management-measurement-reporting configuration comprising a first and a second condition. When the radio-resource-management-measurement-reporting configuration is received, it may be received from a network node. The method also includes, at 520, determining if the first condition has been fulfilled. The first condition comprises a condition based on a channel-state-information-reference-signal measurement. The method also in-cludes, at 530, determining if the second condition has been fulfilled. The second condition comprises a condition based on a cell-specific-reference signal measurement. The method also includes, at 540, reporting, according to the radio-resource-management-measurement-reporting configuration, at least one radio-resource-management measurement based on a channel-state-information reference signal, if both the first condition and the second condition are fulfilled. It should be appreciated that reporting may mean generating a report and/or transmitting the report.

It should be appreciated that the steps/points, signaling messages and related functions described above are in no absolute chronological order.

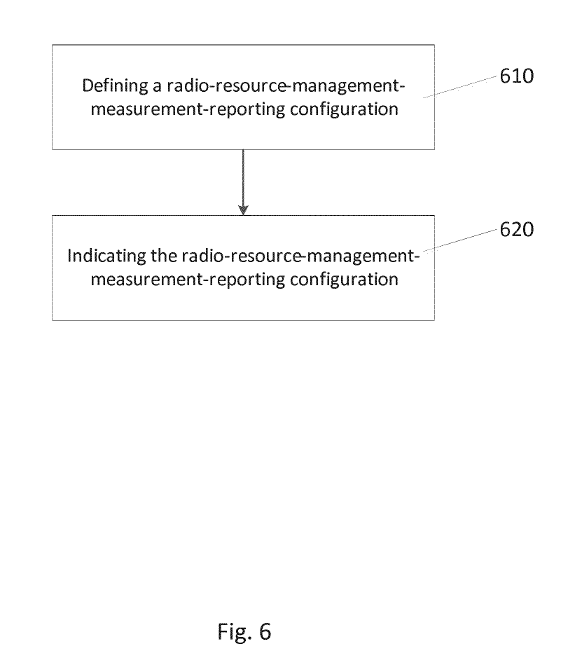

FIG. 6 illustrates a logic flow diagram of a method according to an embodiment of the invention. More detailed examples and further embodiments are described above. The method may be carried out by a network node, such as an eNodeB. The method illustrated in FIG. 6 includes, in one embodiment, at 610, defining a radio-resource-management-measurement-reporting configuration comprising a first and a second condition. The embodiment also includes, at 620, indicating the radio-resource-management-measurement-reporting configuration comprising the first and the second condition to a user device for radio-resource-management-measurement reporting, and/or indicating an association between a channel-state-information-reference-signal resource configuration and a cell identity to the user device for radio-resource-management-measurement reporting.

It should be appreciated that the steps/points, signaling messages and related functions described above are in no absolute chronological order.

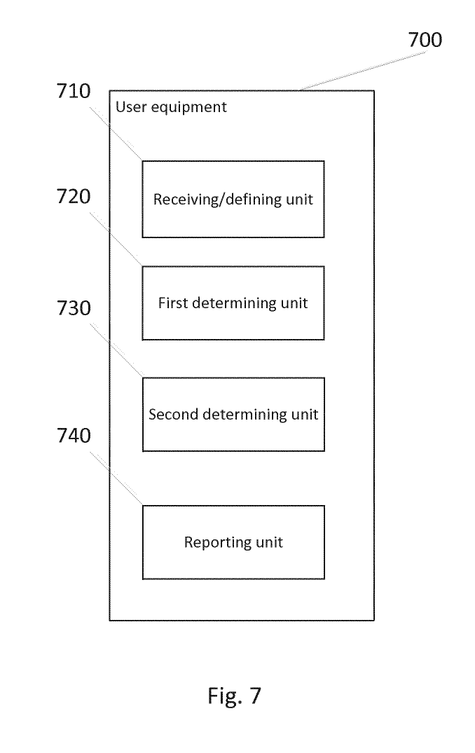

FIG. 7 illustrates an apparatus in accordance with one embodiment. Apparatus 700 includes a receiving/defining unit, module or entity 710 that receives or defines a radio-resource-management-measurement-reporting configuration comprising a first and a second condition. Apparatus 700 also includes a first determining unit 720 that determines if the first condition has been fulfilled. The first condition includes a condition based on a channel-state-information-reference-signal measurement. Apparatus 700 also includes a second determining unit 730 that determines if the second condition has been fulfilled. The second condition comprises a condition based on a cell-specific-reference signal measurement. Apparatus 700 also includes a reporting unit 740 that reports, according to the radio-resource-management-measurement-reporting configuration, at least one radio-resource-management measurement based on a channel-state-information reference signal, if both the first condition and the second condition are fulfilled. The apparatus may be a user device, user equipment or user terminal.

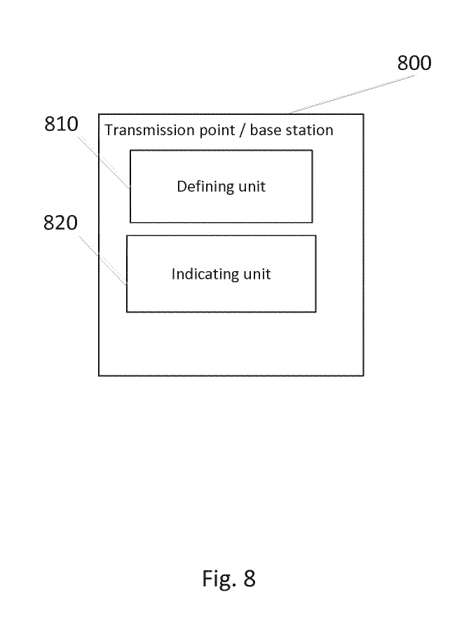

FIG. 8 illustrates an apparatus in accordance with one embodiment. The apparatus 800 may include a defining unit, module or entity 810 that defines a radio-resource-management-measurement-reporting configuration including a first and a second condition. The apparatus may also include an indication unit, module or entity 820 for indicating the radio-resource-management-measurement-reporting configuration comprising the first and the second condition to a user device for radio-resource-management-measurement reporting and/or indicating an association between a channel-state-information-reference-signal resource configuration and a cell identity to the user device for radio-resource-management-measurement reporting. The apparatus may be a node (such as an eNodeB), server or host.

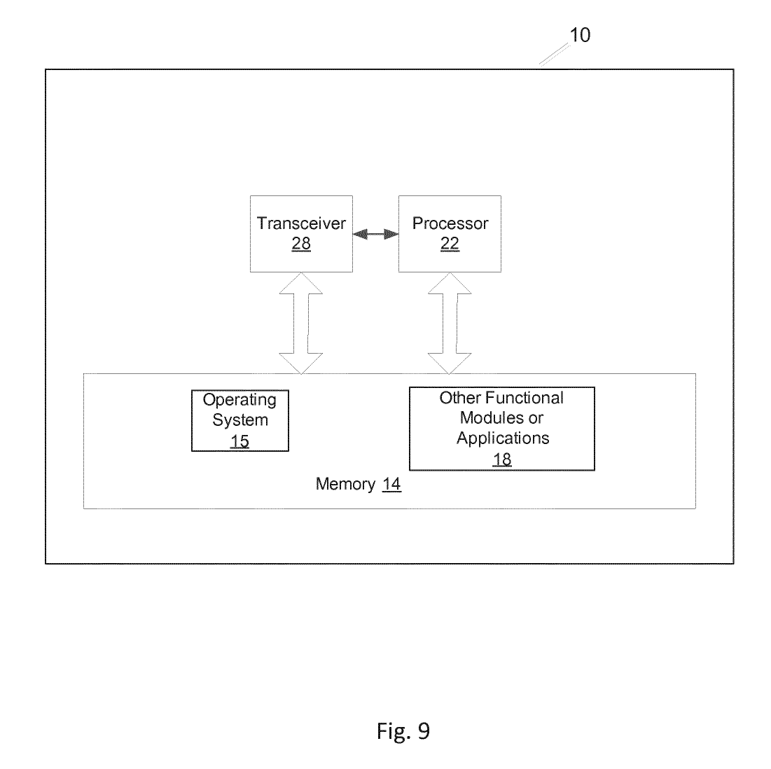

FIG. 9 illustrates an apparatus 10 according to embodiments of the invention. In one embodiment, apparatus 10 may be a transmission point, a base station, node or host for example. In another embodiment, apparatus 10 may be a user equipment, user device or user terminal. The user equipment, user device or user terminal typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, phablet, game console, notebook, and multimedia device. It should be appreciated that a user device may also be a nearly exclusive uplink only device, of which an example is a camera or video camera loading images or video clips to a network.

It should be appreciated that the apparatus may include or otherwise be in communication with a control unit, one or more processors or other entities capable of carrying out operations according to the embodiments described by means of FIGS. 5 and 6. It should be understood that each block of the flowcharts of FIGS. 5 and 6 and any combination thereof may be implemented by various means or their combinations, such as hardware, software, firmware, one or more processors and/or circuitry. Although the apparatus has been depicted as one entity in FIG. 9, different modules (and memory) may be implemented in one or more physical or logical entities. Apparatus 10 may include a processor 22 for processing information and executing instructions or operations. Processor 22 may be any type of general or specific purpose processor. While a single processor 22 is shown in FIG. 9, multiple processors may be utilized according to other embodiments. Processor 22 may also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein. The performed tasks may include the steps illustrated in FIG. 5 or 6. Programs, also called program products or computer programs, including software routines, applets and/or macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. The apparatus-readable or computer-readable data storage medium or distribution medium may be a non-transitory medium. Additionally, software routines or computer program code portions may be downloaded into an apparatus. The computer program may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly. The apparatus may also be operationally coupled to a remote radio head or unit.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In certain embodiments, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

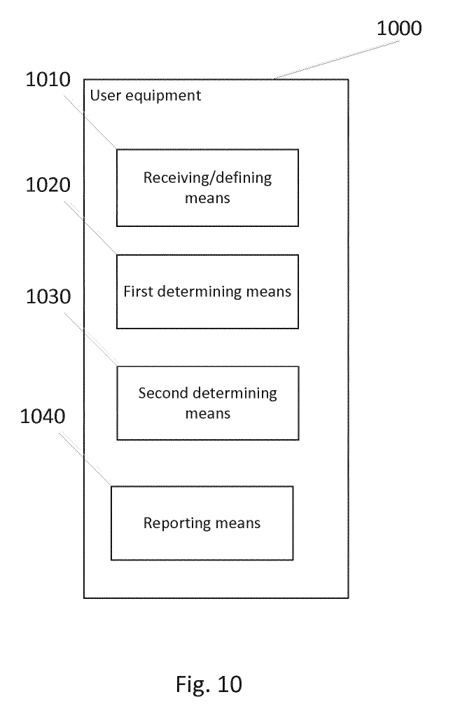

FIG. 10 illustrates an apparatus in accordance with another embodiment. The apparatus 1000 includes (a receiving/defining) means 1010 for receiving or defining a radio-resource-management-measurement-reporting configuration comprising a first and a second condition. The apparatus 1000 may also include a (first determining) means 1020 for determining if the first condition has been fulfilled. The first condition comprises a condition based on a channel-state-information-reference-signal measurement. The apparatus 1000 may also include (second determining) means 1030 for determining if the second condition has been fulfilled. The second condition comprises a condition based on a cell-specific-reference signal measurement. The apparatus 1000 may also include (reporting) means 1040 for reporting, according to the radio-resource-management-measurement-reporting configuration, at least one radio-resource-management measurement based on a channel-state-information reference signal, if both the first condition and the second condition are fulfilled.

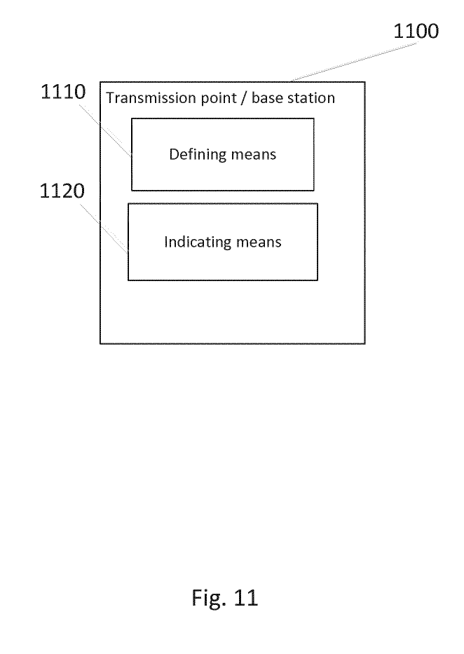

FIG. 11 illustrates an apparatus in accordance with another embodiment. Apparatus 1100 includes (defining) means 1110 for defining a radio-resource-management-measurement-reporting configuration comprising a first and a second condition. Apparatus 1100 may also include (indicating) means 1120 for indicating the radio-resource-management-measurement-reporting configuration comprising the first and the second condition to a user device for radio-resource-management-measurement reporting, and/or indicating an association between a channel-state-information-reference-signal resource configuration and a cell identity to a user device for radio-resource-management-measurement reporting.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-53. (canceled)

54. A method, comprising:
receiving or defining, by a user device, a radio-resource-management-measurement-reporting configuration comprising a first and a second condition;
determining, by the user device, if the first condition has been fulfilled, wherein the first condition comprises a condition based on a channel-state-information-reference-signal measurement;
determining if the second condition has been fulfilled, wherein the second condition comprises a condition based on a cell-specific-reference signal measurement; and
reporting, according to the radio-resource-management-measurement-reporting configuration, at least one radio-resource-management measurement based on a channel-state-information reference signal, if both the first condition and the second condition are fulfilled.

55. The method according to claim 54, wherein the radio-resource-management-measurement-reporting configuration comprises a channel-state-information-reference-signal resource configuration.

56. The method according to claim 54, wherein the first condition and/or the second condition comprises at least one received signal power or received signal quality measurement.

57. The method according to claim 54, wherein the radio-resource-management-measurement-reporting configuration comprises at least one of the following:
an indication to combine the configuration of the first condition and the configuration of the second condition to a third configuration identified by a third identity;
an indication to add the first condition to the configuration of the second condition; and
an indication to add the first condition inside the second condition in the second configuration.

58. The method according to claim 54 wherein the second condition comprises at least one of the following:
measurements based on a serving cell; and
measurements based on a neighboring cell.

59. The method according to claim 54, wherein the radio-resource-management-measurement-reporting configuration comprising the first and second condition, further comprises a first configuration for the first condition and a second configuration for the second condition, wherein the first configuration and/or the second configuration comprises indication of at least one of the following:
measurement gaps;
measurement bandwidth;
carrier frequency;
physical cell identity;
discontinuous reception configuration;
time-to-trigger;
s-Measure;
public land mobile network identity;
configuration on restrictions on measurement occasion times;
type of measured reference symbols; and
measurement interval and filtering parameters.

60. An apparatus, comprising:
at least one processor; and
at least one memory including computer program code,
the at least one memory and the computer program code configured, with the at least one processor, to cause the apparatus at least to:
receive or define a radio-resource-management-measurement-reporting configuration comprising a first and a second condition;
determine if the first condition has been fulfilled, wherein the first condition comprises a condition based on a channel-state-information-reference-signal measurement;
determine if the second condition has been fulfilled, wherein the second condition comprises a condition based on a cell-specific-reference signal measurement; and
report, according to the radio-resource-management-measurement-reporting configuration, at least one radio-resource-management measurement based on a channel-state-information reference signal, if both the first condition and the second condition are fulfilled.

61. The apparatus according to claim 60, wherein the radio-resource-management-measurement-reporting configuration comprises a channel-state-information-reference-signal resource configuration.

62. The apparatus according to claim 60, wherein the first condition and/or the second condition comprises at least one received signal power or received signal quality measurement.

63. The apparatus according to claim 60, wherein the radio-resource-management-measurement-reporting configuration comprises at least one of the following:
an indication to combine the configuration of the first condition and the configuration of the second condition to a third configuration identified by a third identity;
an indication to add the first condition to the configuration of the second condition; and
an indication to add the first condition inside the second condition in the second configuration.

64. The apparatus according to claim 60, wherein the second condition comprises at least one of the following:
measurements based on a serving cell; and
measurements based on a neighboring cell.

65. The apparatus according to claim 60, wherein the radio-resource-management-measurement-reporting configuration comprising the first and second condition, further comprises a first configuration for the first condition and a second configuration for the second condition, wherein the first configuration and/or the second configuration comprises indication of at least one of the following:
measurement gaps;
measurement bandwidth;
carrier frequency;
physical cell identity;
discontinuous reception configuration;
time-to-trigger;
s-Measure;
public land mobile network identity;
configuration on restrictions on measurement occasion times;
type of measured reference symbols; and
measurement interval and filtering parameters.

66. An apparatus, comprising:
at least one processor; and
at least one memory including computer program code,
the at least one memory and the computer program code configured, with the at least one processor, to cause the apparatus at least to
define a radio-resource-management-measurement-reporting configuration comprising a first and a second condition; and
indicate the radio-resource-management-measurement-reporting configuration comprising the first and the second condition to a user device for radio-resource-management-measurement reporting, and/or
indicate an association between a channel-state-information-reference-signal resource configuration and a cell identity to a user device for radio-resource-management-measurement reporting.

67. The apparatus of claim 66, wherein the radio-resource-management-measurement-reporting configuration comprises a channel-state-information-reference-signal resource configuration.

68. The apparatus according to claim 66, wherein the first condition and/or the second condition comprises at least one received signal power or received signal quality measurement.

69. The apparatus according to claim 66, wherein a first offset is added to the first condition and/or a second offset is added to the second condition.

70. The apparatus according to claim 66, wherein the radio-resource-management-measurement-reporting configuration comprises at least one of the following:
an indication to combine the configuration of the first condition and the configuration of the second condition to a third configuration identified by a third identity;
an indication to add the first condition to the configuration of the second condition; and
an indication to add the first condition inside the second condition in the second configuration.

71. The apparatus according to claim 66, wherein the second condition comprises at least one of the following:
measurements based on a serving cell; and
measurements based on a neighboring cell.

72. The apparatus according to claim 66, wherein the radio-resource-management-measurement-reporting configuration comprising the first and second condition, further comprises a first configuration for the first condition and a second configuration for the second condition, wherein the first configuration and/or the second configuration comprises indication of at least one of the following:
measurement gaps;
measurement bandwidth;
carrier frequency;
physical cell identity;
discontinuous reception configuration;
time-to-trigger;
s-Measure;
public land mobile network identity;
configuration on restrictions on measurement occasion times;
type of measured reference symbols; and
measurement interval and filtering parameters.
